(19) United States
(12) Patent Application Publication
(10) Pub. No.: US 2001/0012303 A1
(43) Pub. Date: Aug. 9, 2001

(54) METHOD AND SYSTEM TO DELIVER TARGETED ADVERTISEMENT AND TARGETED CONTENT IN BROADCAST SYSTEM

(75) Inventors: GEORGE GREGORY GRUSE, LIGHTHOUSE POINT, FL (US); KENNETH LOUIS MILSTED, BOYNTON BEACH, FL (US); MARCO M. HURTADO, BOCA RATON, FL (US); GLEN EDWARD HAMBLIN, BOCA RATON, FL (US); PATRICIA HAMBLIN, BOCA RATON, FL (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION

(21) Appl. No.: 08/979,618

(22) Filed: Nov. 28, 1997

(51) Int. Cl. H04J 3/24

(52) U.S. Cl. 370/486; 370/473

(57) ABSTRACT

A receiver for selectively receiving a plurality of broadcast transmissions comprising a broadcast stream and an associated supplemental informational content stream, comprises: (1) selection means for user selection of at least one of the plurality of broadcast transmissions; (2) broadcast presentation means for presenting the selected broadcast streams of the selected broadcast transmission; and (3) supplemental informational content presentation means for presenting the associated supplemental informational content streams associated with the selected broadcast stream in the broadcast transmission.

### BACKGROUND OF THE INVENTION

The present invention relates to data communications networks and more specifically to content information providing for broadcast systems.

The evolution of broadcasting systems has resulted in the availability of a great variety of programs available for users. This is specially true in cable-based subscriber systems wherein the subscriber can select among several program alternatives during a variety of times slots. Moreover, the Internet, and more specifically the World-Wide Web or simply “the Web,” has given its users a great choice of program content. The possibilities for programming flexibility arising from global networks providing digital transmissions are still great.

Often digital broadcast providers would like to give opportunities to their audience to receive additional information related to a particular broadcast. For example, in a radio broadcast, the additional information can be keyed to the musical category, the song, the title or the artist. Many business and organizations have a desire to increase the cross selling of products and information related to particular broadcast content. Returning to the radio broadcast example, the producers, the publishers, the artist, the broadcaster, or even the local cable operator may want to provide content information related to a work being performed. For example, a musical work being performed, the local cable provider may want to provide advertisement information on tickets, other music by the artist, such as CDS, t-shirts, to the listener. Therefore, a need exists to provide targeted content to a broadcast audience.

### SUMMARY OF THE INVENTION

Briefly, in accordance with the invention, a receiver for selectively receiving a plurality of broadcast transmissions comprising a broadcast stream and an associated supplemental informational content stream, comprises: (1) selection means for user selection of at least one of the plurality of broadcast transmissions; (2) broadcast rendering means for rendering the selected broadcast streams of the selected broadcast transmission; and (3) supplemental informational content presentation means for presenting the associated supplemental informational content streams associated with the selected broadcast stream in the broadcast transmission.

### BRIEF DESCRIPTION OF THE DRAWING(S)

FIG. 1 shows a conceptual structure for a digital audio/video receiver in accordance with the invention.

FIG. 2 is a simplified conceptual illustration of an music (audio) packet in accordance with the invention.

FIG. 3 illustrates the association of broadcast stream and associated supplemental informational content stream according to the present invention.

FIG. 4 shows an alternative embodiment of a conceptual structure for a digital audio/video receiver in accordance with the invention.

FIG. 5 shows an alternative embodiment of a conceptual structure for a digital audio/video receiver in accordance with the invention.

FIG. 6 shows an alternative embodiment of a conceptual structure for a digital audio/video receiver in accordance with the invention.

FIG. 7 shows an alternative embodiment of a conceptual structure for a digital audio/video receiver in accordance with the invention.

FIG. 8 shows an alternative embodiment of a conceptual structure for a digital audio/video receiver in accordance with the invention.

FIG. 9 shows digital signal packets and a digital broadcast stream to be used in accordance with the present invention.

### DESCRIPTION OF PREFERRED EMBODIMENT(S)

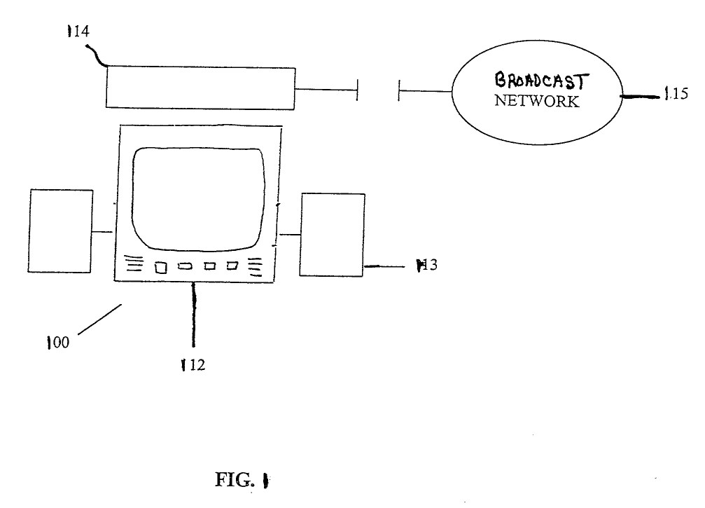

FIG. 1 there is shown a block diagram of a digital receiver system 100 in accordance with one aspect of the invention. The system 100 comprises a monitor unit 112 for receiving and presenting audio and video programs to a user. The unit 112 can be a personal computer monitor or a common commercially-available television set or stereo system. Unit 112 may support stereo and surround sound recorded in enhanced formats such as Dolby B, C directed to auxiliary speakers 113 for realistic, theater-like sound systems. A home receiver unit 114 also receives audio and video signals and is connected to the receiver unit 112 such that the received content is viewed and/or heard by the user. The receiver unit 114 can receive the broadcast programs either by over-the-air means or by cable. The receiver unit 114 can receive the following types of signals DSS, Satellite, Direct TV, Primestar, WebTV, Direct PC, cable digital signals or programming in accordance with a common protocol.

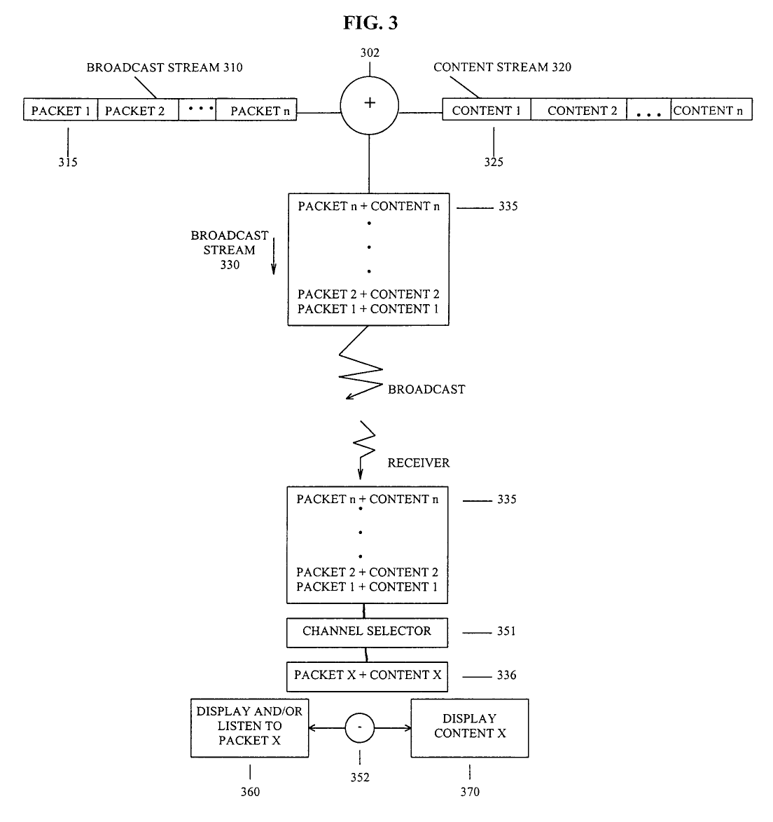

FIG. 3 illustrates an association of broadcast stream and associated supplemental informational content stream according to the present invention. Broadcast stream 310 is a typical block diagram for digital protocol transmitting a plurality of channels of information. Packets 315 (i.e., packet 1, packet 2, . . . packet n) represent time slices of broadcast programs for a plurality of broadcast channels. The broadcast programs can be television, radio, on demand video, pay per view, etc.

In FIG. 9, there is shown a broadcast transmission system packet based signals 900. In this case, the broadcast signals are songs 1-3 (902-906). An interleaved/asynchronously multiplexed broadcast stream 908 comprises signals 902-906. As is illustrated, the packets of programs 902-906 are pieced together in a different order in the broadcast stream 908. A receiver such as unit 108 receives the broadcast stream 908, demultiplexes it and places the packets in an order suitable for presentation to a user. As is also evident from the illustration, the broadcast stream 908 comprises packets identifying the program they belong in. Other data is included in the stream that indicates where in the transmission each packet belongs and data indicating the end of a program (a song in this example). The receiver 114 includes de-multiplexing and decoding circuitry and programming producing an isolated or filtered signal of the program the user has chosen to listen to. Thus, the receiver unit 114, which is operating in accordance with the appropriate protocol, can use these data to piece together each song for presentation to a user.

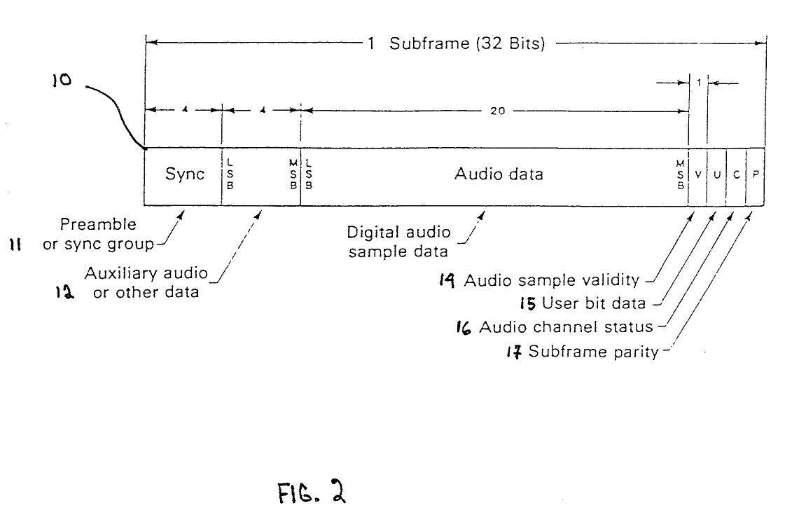

Returning now to FIG. 3, content stream 320 consists of a series of content packets 325 (i.e., content 1, content 2, . . . content 3). Each content packet represents time slices of supplemental informational content to be associated with a broadcast packet. The content in each packet can be merchandising information. For example, suppose packet 1, out of packets 315, in broadcast stream 310, represents a music packet for a song being broadcasted. The music packet is a time slice of the digital recording of a particular song broadcasted in discrete packets. FIG. 2 is a simplified conceptual illustration of an music (audio) packet 210 for an audio broadcast in accordance with the invention. Depicted is the “serial Transmission Format for Linearly Represented Digital Audio Data” recommended by the Audio Engineering Society (ANSI S4.40-1985). For a stereo broadcast, typically two of the music packet frames 210 are sent in sequence, one for each channel. Music packet frame 210 contains audio signal data 213 occupying either 20 or 24 bits of the sub-frame packet, preceded by 4 bit of synchronization 211 and identifying preamble 212 for designating the start of a music packet frame. Following the audio data are 4 bits validity bits 214 whether the previous audio sample data bit are valid; user data bits 215 for assisting the user of the data; channel status 216 for information about system parameters; and parity 217 for detection of broadcast transmission errors. It is important to note that the exact configuration of music packet frame 210 is not important for this present invention.

Referring to FIG. 3, the broadcaster of the song through market demographics appropriate to the song's artist or genre can select targeted information for the listener. A song in a particular genre may have ticket information for upcoming concerts, news about the artist, information on ordering merchandise such as cassettes, CDS or videos related to the artist, jackets, t-shirts, buttons, posters. The choice of the association of the supplemental informational content is predetermined prior to broadcast of the packet 315 in broadcast stream 310. An association operation 302 associates each packet 315 with its corresponding content 325 so that the resulting broadcast stream 330 consists of associated broadcast packets and content packets 335. Broadcast stream 335 is broadcasted to home receivers 114. A user would select a desired program 351 and the packet-X and content-X of selected packet 336, representing one of a set of associated packets from broadcast stream 330. Next, selected packet 336 is separated by a disassociation method 352. A variety of techniques well understood in the art can be used to implement packet disassociation method 352 and the complementary packet association method 302. Known association/disassociation packet methods include packet identifiers, packet numbering and link lists. Returning to the example above for an audio transmission, packet-X of selected packet 336 is played on an audio system, such as through speakers 113 of FIG. 1 and simultaneously the supplemental informational content of content-X of selected packet 336 is displayed on display 112 of FIG. 1. A user can view information associated with the song. It is important to note that the content association can be done by the broadcast stream content provider, the local broadcaster or local cable provider so that the target broadcast recipients can be more narrowly focused.

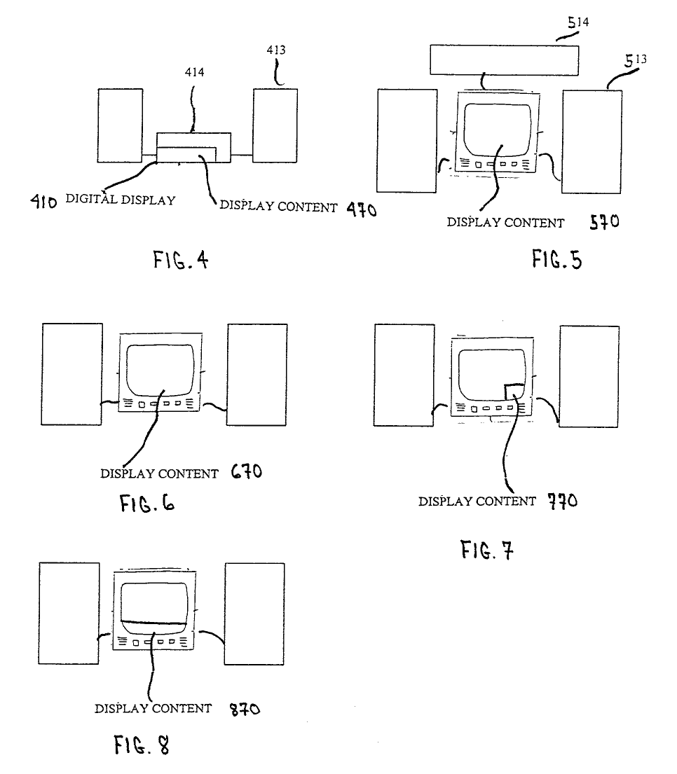

Referring to FIGS. 4-8, there are illustrated a variety of conceptual hardware implementations according to the present invention embodying the display of content 370 of FIG. 3. Digital display 410 in FIG. 4 represents a monochrome or color LCD or equivalent display on an audio receiver through which content-X of selected packet 336 is displayed while concurrently listening to an audio broadcast through receiver 414 being played through speakers 413. FIG. 5 shows an alternative embodiment in which context x of selected packet 336 is displayed on a monitor or television screen 512. FIG. 6 illustrates an embodiment where the digital receiver 514 of FIG. 5 is integrated into the monitor or television screen 512.

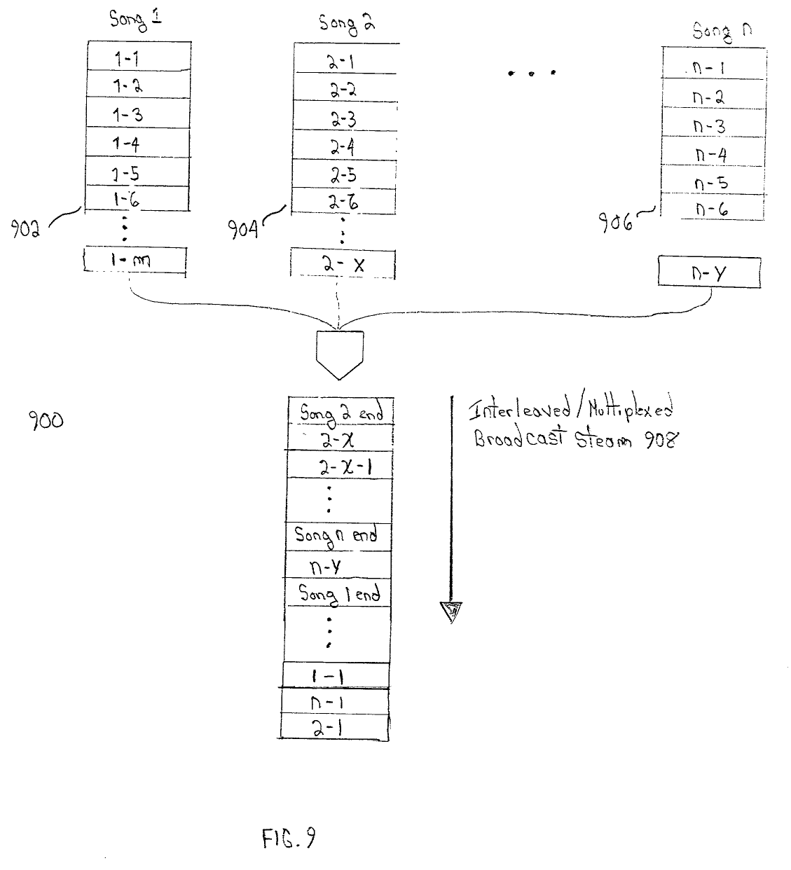

In an alternate embodiment, FIG. 7 illustrates the broadcast program as a video broadcast such as broadcast television or high definition television (HDTV) with the supplemental informational content being displayed in a rectangular area on the screen during viewing in a separate window as supported by picture-in-picture technology or in a web browser implementation supporting multiple frame technology. An elongated rectangular area for displaying information content while concurrently viewing a broadcast program is illustrated in FIG. 8.

While the invention has been illustrated and described in the preferred embodiments, many modifications and changes therein may be affected by those skilled in the art. It is to be understood that the invention is not limited to the precise construction disclosed herein and that the scope of the invention is defined only by the claims appended hereto and equivalents. Accordingly, the right is reserved to all changes and modifications coming within the true spirit and scope of the invention.

What is claimed is:

1. A broadcast system for broadcasting a plurality broadcast streams, said broadcast system comprising:
a transmitter for broadcasting said plurality of broadcast streams; and
insertion means for inserting a plurality of supplemental informational content streams into said broadcast streams at said transmitter; each part of said plurality of supplemental informational content stream associated with at least one of said plurality broadcast streams.

2. The broadcast system of claim 1 further comprising:
a receiver comprising a display and a selector from which a user can selects to receive at least one of said plurality of broadcast streams wherein said associated supplemental informational content is displayed on said display while said broadcast stream is being presented.

3. The broadcast system of claim 2 wherein said broadcast stream is an audio broadcast stream and said supplemental informational content stream is a video broadcast stream.

4. The broadcast system of claim 3 wherein said supplemental informational content is advertisement specifically associated with said audio broadcast stream.

5. A receiver for selectively receiving a plurality of broadcast transmissions comprising a broadcast stream and an associated supplemental informational content stream; said receiver comprising:
selection means for user selection of at least one of said plurality of broadcast transmissions;
broadcast presentation means for presenting said selected broadcast streams of said selected broadcast transmission; and
supplemental informational content presentation means for presenting said associated supplemental informational content streams associated with said selected broadcast stream in said broadcast transmission.

6. The receiver of claim 5 wherein said broadcast stream is an audio broadcast stream and said supplemental informational content stream is a video broadcast stream.

7. The receiver of claim 6 wherein said supplemental informational content is advertisement specifically associated with said audio broadcast stream.

8. In an information processing system comprising a display and a receiver for selectively receiving a plurality of broadcast transmissions consisting of an audio broadcast stream and an associated supplemental informational content stream; said receiver comprising:
a selection means for user selection of at least one of said plurality of broadcast transmissions;
an audio broadcast stream reception means for playing said selected broadcast transmission;
an information content presentation means for presenting said associated informational on said display while playing said selected audio broadcast stream.

9. The receiver of claim 8 wherein said broadcast stream is an audio broadcast stream and said supplemental informational content stream is a video broadcast stream.

10. The receiver of claim 9 wherein said supplemental informational content is advertisement specifically associated with said audio broadcast stream.

11. A method of receiving supplemental informational content from a broadcast transmission; said broadcast stream consisting of an audio broadcast stream and an associated supplemental informational content stream; said method comprising the steps of:
user selection of one of said broadcast transmissions;
playing said audio broadcast stream from said selected broadcast transmission; and
presenting said associated supplemental informational content while playing said selected audio broadcast stream.
